(19) United States
(12) Patent Application Publication
(10) Pub. No.: US 2017/0212369 A1
(43) Pub. Date: Jul. 27, 2017

(54) THREE-DIMENSIONAL IMAGE DISPLAY DEVICE AND METHOD FOR DRIVING THE SAME

(71) Applicant: Samsung Display Co., Ltd., Yongin-si (KR)

(72) Inventor: Beom Shik KIM, Yongin-si (KR)

(21) Appl. No.: 15/415,463

(22) Filed: Jan. 25, 2017

(30) Foreign Application Priority Data
Jan. 26, 2016 (KR) 10-2016-0009652

(51) Int. Cl. G02F 1/137; G02B 27/22; G02F 1/1343; G02F 1/29; G09G 3/00; G09G 3/36

(52) U.S. Cl. CPC G02F 1/137; G09G 3/003; G09G 3/3648; G02F 1/134309; G02F 1/292; G02B 27/2214

(57) ABSTRACT

A 3D image display device includes: a display panel configured to display an image; a liquid crystal lens panel configured to selectively form a plurality of first lenses each extending in a first direction and successively arranged along a second direction which crosses the first direction, and to selectively form a plurality of second lenses each extending in the second direction and successively arranged along the first direction; and a polarization switching panel formed between the display panel and the liquid lens panel, the polarization switching panel configured to selectively alter an optical axis of light incident from the display panel.

### RELATED APPLICATION

This application claims priority to, and the benefit of, Korean Patent Application No. 10-2016-0009652 filed in the Korean Intellectual Property Office on Jan. 26, 2016, the entire contents of which are herein incorporated by reference.

### BACKGROUND

(a) Field

An exemplary embodiment of the described technology relates generally to display devices. More specifically, an exemplary embodiment of the described technology relates to 3D image display devices and methods for driving such 3D image display devices.

(b) Discussion of Related Art

Display devices have been developed that can display a three-dimensional (3D) image. In general, in 3D image display, a 3D effect of an object is accomplished by implementing binocular parallax. That is, when different 2D images are seen by a left eye and a right eye, the image (hereinafter referred to as “left eye image”) seen by the left eye and the image (hereinafter referred to as “right eye image”) seen by the right eye are both transferred to the brain. Together, the left eye image and the right eye image are recognized as a 3D image having depth perception, thus achieving a 3D effect. A display device may use either a stereoscopic method or an autostereoscopic method to display 3D images using binocular parallax.

The stereoscopic method requires a viewer to wear glasses, while the autostereoscopic method employs optical modulation devices within the display device, so that viewers do not need to wear glasses. 3D display devices that use the autostereoscopic method transmit different images with different viewpoints, so that a viewer can perceive the image as a stereoscopic image.

The above information disclosed in this Background section is only for enhancement of understanding of the background of the invention and therefore it may contain information that does not form the prior art that is already known in this country to a person of ordinary skill in the art.

### SUMMARY

Embodiments of the present disclosure can provide a 3D image display device and a method of its driving, that can provide a more natural 3D effect to a user. Further, embodiments of the present disclosure can provide a 3D image display device and associated driving methods that can switch between a 3D mode and a 2D mode.

According to an exemplary embodiment, a 3D image display device includes: a display panel configured to display an image; a liquid crystal lens panel configured to selectively form a plurality of first lenses each extending in a first direction and successively arranged along a second direction which crosses the first direction, and to selectively form a plurality of second lenses each extending in the second direction and successively arranged along the first direction; and a polarization switching panel formed between the display panel and the liquid lens panel, the polarization switching panel configured to selectively alter an optical axis of light incident from the display panel.

The polarization switching panel may include: a first panel including a lower panel electrode; a second panel facing the first panel and including an upper panel electrode; and a first liquid crystal layer between the first panel and the second panel and including a plurality of liquid crystal molecules.

The first panel may further include a first aligner aligned in the first direction and the second panel may further include a second aligner aligned in the second direction.

The polarization switching panel may be configured to change the optical axis of light according to a difference between a voltage applied to the lower panel electrode and a voltage applied to the upper panel electrode.

The liquid crystal lens panel may be further configured to form the plurality of first lenses while the polarization switching panel alters the optical axis of light.

The liquid crystal lens panel may include a plurality of first electrodes extended in the first direction and successively arranged along the second direction, as well as a plurality of second electrodes extended in the second direction and successively arranged along the first direction, wherein the first lenses may be formed when a first voltage is applied to the plurality of first electrodes and a first common voltage different from the first voltage is applied to the plurality of second electrodes.

The liquid crystal lens panel may include: a first panel including the plurality of first electrodes, an insulation layer on the plurality of first electrodes, and the plurality of second electrodes on the insulation layer; a second panel facing the first panel and including an upper panel electrode; and a second liquid crystal layer between the first panel and the second panel and including a plurality of liquid crystal molecules.

The liquid crystal lens panel may include a first panel including a lower panel electrode and a first insulation layer on the lower panel electrode, the plurality of first electrodes on the first insulation layer. The liquid crystal lens panel may also include a second panel facing the first panel and including the plurality of second electrodes, as well as a second liquid crystal layer between the first panel and the second panel and including a plurality of liquid crystal molecules.

According to an exemplary embodiment, a method of driving a 3D image display device which includes a display panel displaying an image, a liquid crystal lens panel, and a polarization switching panel between the display panel and the liquid lens panel includes: during a first frame period and when the display panel is driven in a 3D mode for display of a 3D image, forming a plurality of first lenses each extending in a first direction and successively arranged along a second direction which crosses the first direction; and during a second frame period subsequent to the first frame period, and while the display panel is driven in the 3D mode, forming a plurality of second lenses extended in the second direction arranged in the first direction during a second frame subsequent to the first frame.

The forming a plurality of first lenses may include driving the polarization switching panel to change an optical axis of light during the first frame period.

The forming a plurality of second lenses may include driving the polarization switching panel to sustain the optical axis of light during the second frame period.

The polarization switching panel may include a first panel including a lower panel electrode, a second panel facing the first panel and including an upper panel electrode, and a first liquid crystal layer between the first panel and the second panel and including a plurality of liquid crystal molecules. The driving the polarization switching panel may further include applying different voltages to the lower panel electrode and the upper panel electrode.

The liquid crystal lens panel may include a plurality of first electrodes extended in the first direction and successively arranged along the second direction, and a plurality of second electrodes extended in the second direction and successively arranged along the first direction, and the forming a plurality of first lenses may further include applying a first voltage to the plurality of first electrodes and a second voltage to the plurality of second electrodes, the first voltage being different from the second voltage.

According to an exemplary embodiment, a 3D image display device includes: a display panel configured to display an elemental image obtained from different viewpoints of a 3D object; a polarization switching panel on the display panel and programmed to alternately change an optical axis of light of the elemental image during consecutive frames; and a liquid crystal panel configured to form, during respective and consecutive image frame periods, a plurality of first lenses each extending in a first direction and successively arranged along a second direction which crosses the first direction, and a plurality of second lenses each extending in the second direction and successively arranged along the first direction.

According to an exemplary embodiment, a liquid crystal lens panel includes: a first panel including a plurality of first electrodes extended in a first direction and arranged along a second direction different from the first direction, and a plurality of second electrodes extended in the second direction and arranged along the first direction; a second panel facing the first panel and including an upper panel electrode; and a liquid crystal layer between the first panel and the upper panel electrode and including a plurality of liquid crystal molecules.

The first panel may further include a first substrate on which the plurality of first electrodes is located; and an insulation layer on the plurality of first electrodes, wherein the plurality of second electrodes is positioned on the insulation layer.

The second panel may further include a second substrate on which the upper panel electrode is located.

According to an exemplary embodiment, a liquid crystal lens panel includes: a first panel including a plurality of first electrodes extended in a first direction and arranged along a second direction different from the first direction, and an lower panel electrode; a second panel facing the first panel and including a plurality of second electrodes extended in the second direction and arranged along the first direction, and an upper panel electrode; and a liquid crystal layer between the plurality of first electrodes and the plurality of second electrodes and including a plurality of liquid crystal molecules.

The first panel may further include a first substrate on which the lower panel electrode is located; and a first insulation layer on the lower panel electrode, wherein the plurality of first electrodes is positioned on the first insulation layer.

The second panel may further include a second substrate on which the upper panel electrode is located; and a second insulation layer on the upper panel electrode, wherein the plurality of second electrodes is positioned on the first insulation layer.

According to at least one of the exemplary embodiments, it is possible to increase a natural 3D effect of a 3D image recognized by a user.

According to at least one of the exemplary embodiments, it is possible to switch between a 3D mode for displaying a 3D image and a 2D mode for displaying a 2D image.

Additional scope of applicability of the present disclosure will be recognized from the following detailed description. However, various changes and modifications within the scope of the present disclosure may be clearly understood, and therefore the detailed description and specific embodiments such as the exemplary embodiments are to be construed as being given only as examples.

### BRIEF DESCRIPTION OF THE DRAWINGS

FIG. 1 and FIG. 2 are block diagrams illustrating a 3D image display device according to an exemplary embodiment.

FIG. 3 and FIG. 4 are diagrams illustrating arrangements of the liquid crystal molecules of a 3D image display device according to an exemplary embodiment.

FIG. 5 is a perspective view illustrating the 3D image display device according to an exemplary embodiment.

FIG. 6 and FIG. 7 are timing diagrams for a method of driving a 3D image display device according to an exemplary embodiment.

FIG. 8 is a perspective view illustrating the 3D image display device according to an exemplary embodiment.

FIG. 9 and FIG. 10 are timing diagrams for a method of driving a 3D image display device according to an exemplary embodiment.

### DETAILED DESCRIPTION OF THE EMBODIMENTS

Hereinafter, exemplary embodiments disclosed in the specification will be described in detail with reference to the accompanying drawings. In the specification, the same or similar components will be denoted by the same or similar reference numerals, and duplicate descriptions thereof will be omitted. The terms “module” and “unit” for components used in the following description are used only in order to make the specification clearer. Therefore, these terms do not have meanings or roles that distinguish them from each other by themselves. In describing exemplary embodiments of the specification, when it is determined that a detailed description of the well-known art associated with the invention may obscure the gist of the invention, it will be omitted. The accompanying drawings are provided only in order to allow exemplary embodiments disclosed in the specification to be easily understood and are not to be interpreted as limiting the spirit disclosed in the specification, and it is to be understood that the invention includes all modifications, equivalents, and substitutions without departing from the scope of the invention.

In the drawings, the thickness of layers, films, panels, regions, etc., are exaggerated for clarity. The various figures thus may not be to scale. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. All numerical values are approximate, and may vary. All examples of specific materials and compositions are to be taken as nonlimiting and exemplary only. Other suitable materials and compositions may be used instead.

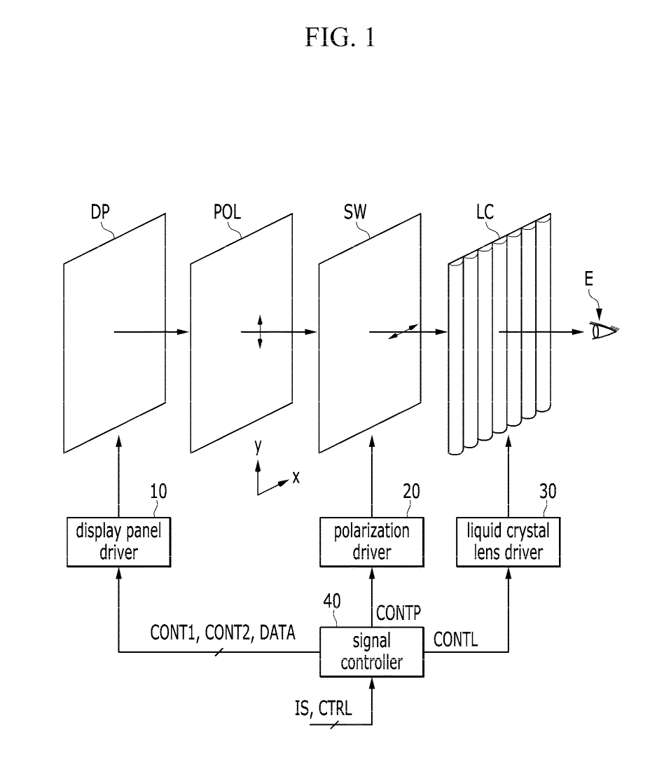

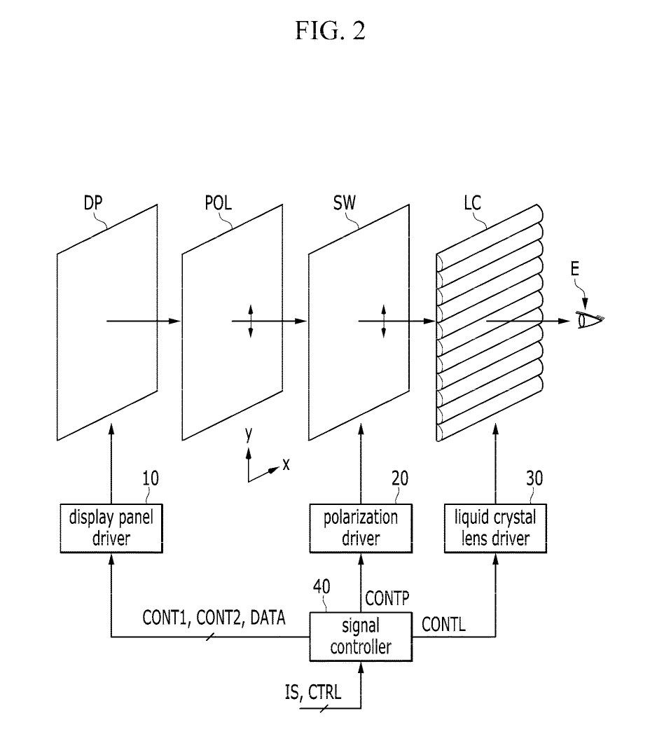

Referring to FIG. 1 and FIG. 2, a 3D image display device according to an exemplary embodiment will be described.

FIG. 1 and FIG. 2 are block diagrams illustrating a 3D image display device according to an exemplary embodiment.

Referring to FIG. 1 and FIG. 2, a 3D image display device may include a display panel DP, a polarizing plate POL, a display panel driver 10, a polarization switching panel SW, a polarization driver 20, a liquid crystal lens panel LC, a liquid crystal lens driver 30, and a signal controller 40.

It is understood that implementing all of the illustrated components is not a requirement, and that greater or fewer components may alternatively be implemented.

The display panel DP may display an image, and may for example be one of a plasma display panel, a liquid crystal display panel, and an organic light emitting diode panel.

The display panel DP may include a plurality of signal lines, and a plurality of pixels connected to the plurality of signal lines. The plurality of pixels may be arranged in a matrix form.

Each pixel may include switching elements (e.g., thin film transistors) connected to the plurality of signal lines, and pixel electrodes connected to the switching elements. The plurality of signal lines may include a plurality of gate lines transmitting gate signals, and a plurality of data lines transmitting data signals. Electrical signals may be transmitted from the display panel driver 10 to the pixels. Accordingly, the display panel DP may display the image.

In a 3D mode, the display panel DP may display an elemental image taken from different viewpoints, for display of a 3D object.

The polarizing plate POL may be disposed between the display panel DP and the polarization switching panel SW. The polarizing plate POL may polarize light from the display panel DP into linearly polarized light.

The polarization switching panel SW may be switched so that a polarization direction of the linearly polarized light being passed through the polarizing plate POL is altered. The polarization switching panel SW may change the polarization direction in accordance with signals supplied from the polarization driver 20.

As shown in FIG. 1, when the polarization switching panel SW is turned on, the polarization direction of light passing through the polarizing plate POL may be changed from the first direction (e.g., y-axis direction) to the second direction (e.g., x-axis direction). Further, as shown in FIG. 2, when the polarization switching panel SW is turned off, the polarization direction of light passing through the polarizing plate POL may be sustained in the first direction. Then, the light having passed through the polarization switching panel SW may be incident to the liquid crystal lens panel LC.

Specifically, the polarization switching panel SW may electrically control a liquid crystal layer interposed between an upper electrode and a lower electrode, so that an optical axis of light incident from the display panel DP is selectively changed. Thus, in 2D mode, light of a 2D image may pass through the polarization switching panel SW without having its optical axis changed. In 3D mode, the polarization switching panel SW may alternately change the optical axis of light of a 3D image for every sub-frame.

The liquid crystal layer may be one of twisted nematic (TN) liquid crystal, vertical alignment (VA) liquid crystal, and cholesteric liquid crystal, for example. The liquid crystal layer which will be described hereinafter is exemplarily described as a twisted nematic (TN) liquid crystal layer.

The polarization driver 20 may apply an electrical signal to the polarization switching panel SW. Accordingly, an arrangement of liquid crystal molecules included in the polarization switching panel SW may be changed. Then, in accordance with the arrangement of these liquid crystal molecules, the polarization direction of the light incident to the polarization switching panel SW may be changed.

Specifically, the polarization driver 20 may supply a common voltage to the upper electrode, and periodically reverse the polarity of the driving voltage supplied to the lower electrode. When liquid crystals of the polarization switching panel SW undergo DC driving, charged liquid crystal molecules are accumulated on the alignment layers so as to interfere with alignment of the liquid crystal, so that the pre-tilt angle of the liquid crystal molecules may vary. In this instance, the polarization driver 20 prevents sticking of the liquid crystals of the DC image.

The polarization driver 20 may supply different driving voltages in the 2D mode and the 3D mode, according to the control of the signal controller. In 2D mode, the polarization driver 20 may supply a voltage to the polarization switching panel SW so that the light incident from the display panel DP passes through the polarization switching panel SW unchanged. In 3D mode, the polarization driver 20 may supply a voltage to the polarization switching panel SW so that liquid crystals of the polarization switching panel SW rotate for each sub-frame.

The liquid crystal lens panel LC, as the switching lens panel, may transmit unchanged or unmodified light in the 2D mode, and refract or split light in the 3D mode. Such a liquid crystal lens panel LC may implement a plurality of lenticular lenses in accordance with the driving method. That is, the liquid crystal lens panel LC may be driven so as to implement lenticular lenses. The liquid crystal lens driver 30 may drive the liquid crystal lens panel LC so that lenses of any desired size, orientation, and arrangement may be implemented.

For instance, as shown in FIG. 1, the plurality of lenticular lenses implemented by the liquid crystal lens panel LC may extend in the y-axis direction and arranged successively along the x-axis direction. The direction of extension of each of the lenticular lenses may be substantially parallel with the column direction of the pixels or inclined to form an acute angle with the column direction of the pixels, as desired.

Further, as shown in FIG. 2, the plurality of lenticular lenses may each extend in the x-axis direction and be arranged so that successive lenses are placed along the y-axis direction. The direction of extension of each of the lenticular lenses may be substantially parallel with the row direction of the pixels or inclined to form an acute angle with the row direction of the pixels, as desired.

When the light passing through the liquid crystal lens panel LC is incident to the user's eye E, the user may recognize the light passing through at the same point in time as a single image.

Thus, when in the 3D mode, the liquid crystal lens panel LC may refract the elemental image displayed in the display panel DP so the user at a predetermined distance from the 3D image display device may see two different views of the image corresponding to two different viewpoints, so that viewers recognize a 3D image. To this end, the liquid crystal lens panel LC may refract the image in accordance with the viewpoints used in taking the elemental image, thereby changing the arrangement direction of the lenticular lenses by a sub-frame unit.

The signal controller 40 may receive an input image signal IS and an input control signal CTRL from an external source. The input video signal IS may contain luminance information for each of the pixels of the display panel, and the luminance may be divided into a predetermined number, such as 1024, 256, or 64 gray levels. The input control signal CTRL may include a vertical synchronization signal, a horizontal synchronization signal, a main clock signal, a data enable signal, and the like regarding display of the image.

The signal controller 40 may process the image signal IS according to operating conditions of the display panel DP, the input image signal IS and the input control signal CTRL, and generate a data control signal CONT1, a scan control signal CONT2, a polarization control signal CONTP, and a liquid crystal lens control signal CONTL.

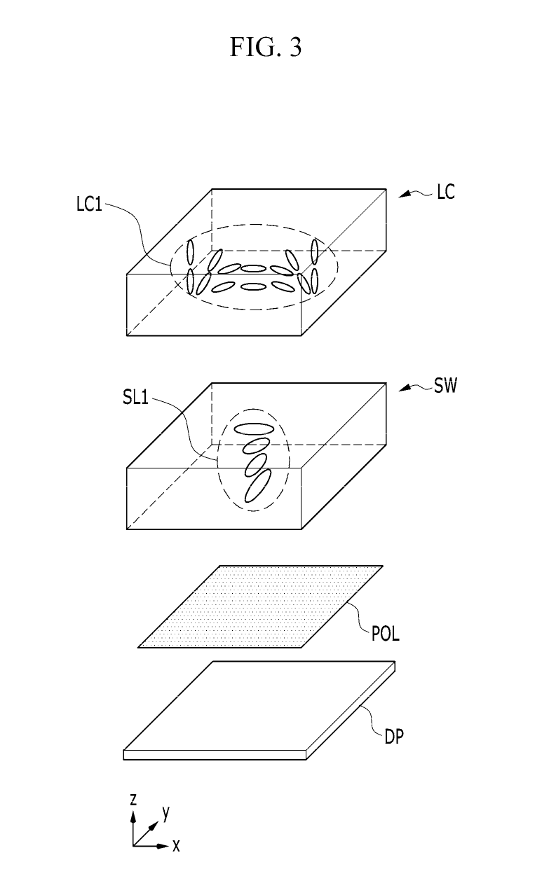

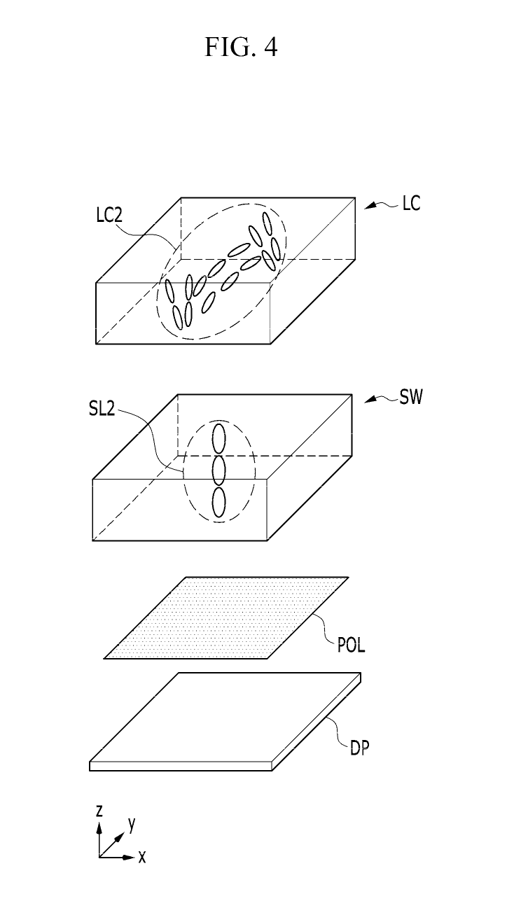

Referring to FIG. 3 and FIG. 4, arrangements of the liquid crystal molecules in the 3D mode of the 3D image display device according to an exemplary embodiment will now be described.

FIG. 3 and FIG. 4 are diagrams illustrating arrangements of the liquid crystal molecules of a 3D image display device according to an exemplary embodiment. The 3D image display device may include the polarizing plate POL on the display panel DP, and the polarization switching panel SW and the liquid crystal lens panel LC on the polarizing plate POL.

The liquid crystal layer of the polarization switching panel SW may include liquid crystal molecules. The liquid crystal molecules may be twisted nematic liquid crystal molecules.

As shown in FIG. 3, the liquid crystal molecules SL1 of the polarization switching panel SW may be aligned in a direction substantially parallel with the xy plane when an electric field is not generated in the liquid crystal layer. The direction of liquid crystal molecules SL1 may rotate in the xy plane along with the z axis.

More specifically, the major axes of liquid crystal molecules adjacent to the polarizing plate POL are arranged in a direction substantially parallel to the y axis, and the major axes of liquid crystal molecules adjacent to the liquid crystal lens panel LC are arranged in a direction substantially parallel to the x axis. As the liquid crystal molecules are spaced apart from the polarizing plate along the z axis, the azimuth angle of the major axes of the liquid crystal molecules may be changed.

By changing the alignment direction of the liquid crystal molecules SL1, the polarization of light incident to the polarization switching panel SW may be changed. For example, light that is linearly polarized parallel to the y axis is incident to the polarization switching panel SW from the polarizer panel POL, and proceeds along the z axis. The polarization axis of the incident light may be rotated so as to be parallel with the x axis, in accordance with the alignment direction of the liquid crystal molecules SL1 of the polarization switching panel SW.

As shown in FIG. 4, liquid crystal molecules SL2 may be aligned in a direction generally perpendicular to the xy plane when an electric field is generated in the liquid crystal layer. The major axes of the liquid crystal molecules are thus arranged in a direction substantially parallel to the z axis.

By maintaining the alignment direction of the liquid crystal molecules SL2, the polarization of the light incident to the polarization switching panel SW may be sustained. For example, light that is linearly polarized parallel to the y axis may fall incident to the polarization switching panel SW from the polarizer panel POL, and may proceed along the z axis. The polarization of this incident light is sustained parallel to the y axis, in accordance with the alignment direction of the liquid crystal molecules SL2 of the polarization switching panel SW.

As shown in FIG. 3, when an electric field is generated in the liquid crystal layer, its refractive index is changed along the direction parallel to the x axis.

When the polarization direction of light emitted from the polarization switching panel SW is parallel to the x axis, liquid crystal molecules LC1 of the liquid crystal lens panel LC may form a plurality of liquid crystal lenses in which refractive indices are changed along the direction parallel to the x axis.

Further, as shown in FIG. 4, when an electric field is generated in the liquid crystal layer, its refractive index is changed along the direction parallel to the y axis. When the polarization direction of light emitted from the polarization switching panel SW is parallel to the y axis, liquid crystal molecules LC2 of the liquid crystal lens panel LC may form a plurality of liquid crystal lenses in which refractive indices are changed along the direction parallel to the y axis.

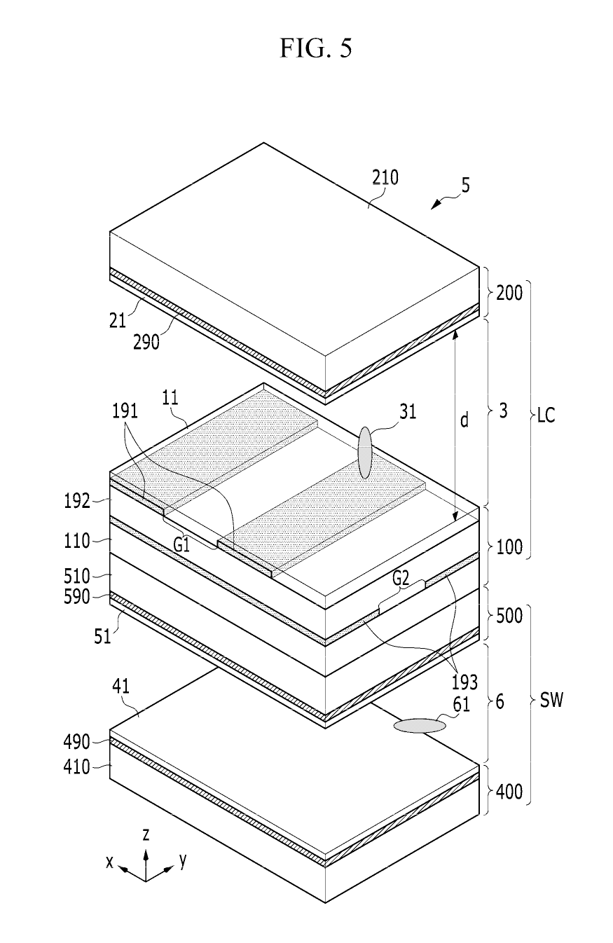

Referring to FIG. 5 to FIG. 7, the 3D image display device and driving method thereof according to an exemplary embodiment will now be described.

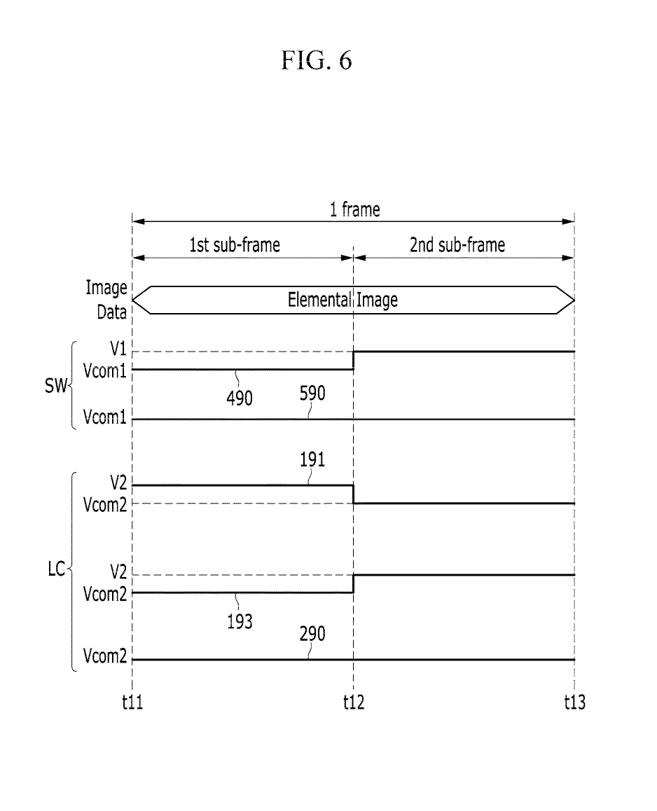

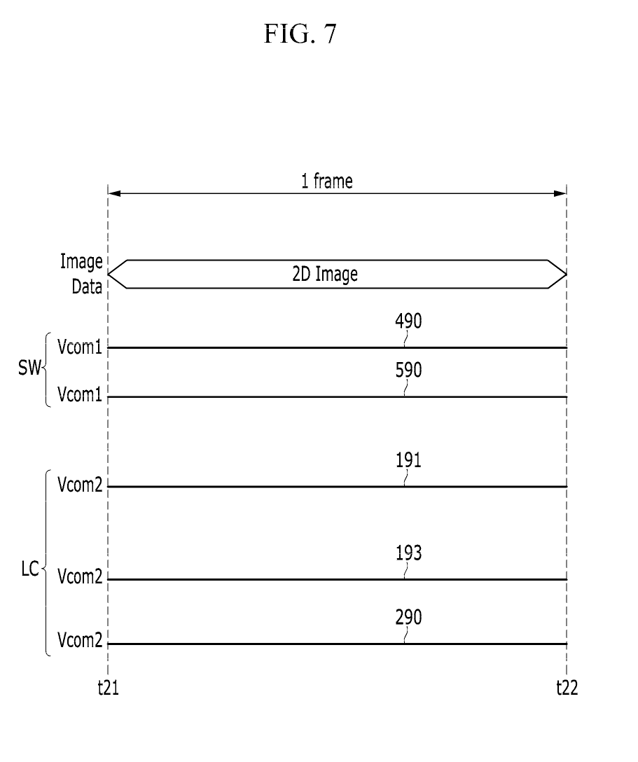

FIG. 5 is a perspective view illustrating the 3D image display device 5 according to an exemplary embodiment, and FIG. 6 and FIG. 7 are timing diagrams for a method of driving the 3D image display device according to an exemplary embodiment.

As shown in FIG. 5, a 3D image display device according to an exemplary embodiment may include a liquid crystal lens panel LC and a polarization switching panel SW.

The liquid crystal lens panel LC may include a first panel 100 and a second panel 200 facing each other, with a liquid crystal layer 3 positioned therebetween.

The first panel 100 may include a first substrate 110 which may be made of glass, plastic, or the like. The first substrate 110 may be rigid or flexible, and may be flat, or at least a part thereof may be curved.

A plurality of first electrodes 193 may be positioned on the first substrate 110. The first electrodes 193 may include a conductive material, and may include a transparent conductive material such as ITO and IZO, a metal, etc. The first electrodes 193 may receive a voltage from the liquid crystal lens driver 30.

The plurality of first electrodes 193 may be successively arranged along a certain direction, for example, the y-axis direction, and each of the first electrodes 193 may extend in a direction perpendicular to the direction of arrangement, for example, the x-axis direction.

A width of a space G2 between adjacent first electrodes 193 may be adjusted as desired, based on a design of the 3D image display device.

An insulation layer 192 may be positioned on the first electrodes 193. The insulation layer 192 may be formed of at least one of an organic insulator and an inorganic insulator.

A plurality of second electrodes 191 may be positioned on the insulation layer 192. The second electrodes 191 may include a conductive material, and in particular may include a transparent conductive material such as ITO and IZO, a metal, etc. The second electrodes 191 may receive a voltage from the liquid crystal lens driver 30.

The plurality of second electrodes 191 may be successively arranged along a certain direction, for example, the x-axis direction, and each of the second electrodes 191 may extend in a direction perpendicular to the direction of arrangement, for example, the y-axis direction.

A width of a space G2 between adjacent second electrodes 191 may be adjusted as desired, based on a design of the 3D image display device.

The second panel 200 may include a second substrate 210 which may be made of glass, plastic, or the like. The second substrate 210 may be rigid or flexible, and may be flat, or at least a part thereof may be curved.

An upper-panel electrode 290 is positioned on the second substrate 210. The upper-panel electrode 290 may include a conductive material, and may include a transparent conductive material such as ITO and IZO, a metal, etc. The upper-panel electrode 290 may receive a voltage from the liquid crystal lens driver 30. The upper-panel electrode 290 may also be formed on the second substrate 210 as a single plate, or may be patterned to have a plurality of separated portions.

The liquid crystal layer 3 includes a plurality of liquid crystal molecules 31. The liquid crystal molecules 31 are substantially perpendicularly aligned with respect to the second panel 200 and the first panel 100 when no electric field is generated in the liquid crystal layer 3, or may have pre-tilts in predetermined directions. The liquid crystal molecules 31 may be nematic liquid crystal molecules.

A height d of a cell gap of the liquid crystal layer 3 may substantially satisfy Equation 1 with respect to light of a predetermined wavelength λ.

$$\frac{λ}{2} \times 1.3 \geq Δ nd \geq \frac{λ}{2} \qquad ( Equation 1 )$$

In Equation 1, Δnd is a phase retardation value of light passing through the liquid crystal layer 3.

A first alignment director 11 is positioned on an inner surface of the first panel 100 over the second electrodes 191, and a second alignment director 21 is positioned on an inner surface of the second panel 200 over the upper-panel electrode 290. The first alignment director 11 and the second alignment director 21 may be vertical alignment layers, and may be provided with an alignment force by various methods, such as a rubbing process or a photo-alignment process, to align the liquid crystal molecules 31 that approach the first panel 100 and the second panel 200 in predetermined pre-tilt directions. When using a rubbing process, the vertical alignment layer may be an organic vertical alignment layer. When using a photo-alignment process, a photo-polymerization material may be formed by irradiating light, such as ultraviolet light, after coating an alignment material that includes a photosensitive polymer material on the inner surfaces of the first panel 100 and the second panel 200.

Alignment directions of the two alignment directors 11 and 21 positioned on the inner surfaces of the first panel 100 and the second panel 200 are substantially parallel to each other.

The polarization switching panel SW may include a third panel 400 and a fourth panel 500 facing each other, with a liquid crystal layer 6 positioned therebetween. The fourth panel 500 of the polarization switching panel SW may be bonded to the first panel 100 of the liquid crystal lens panel LC. Alternatively, the fourth panel 500 of the polarizing switching panel SW and the first panel 100 of the liquid crystal lens panel LC may be the same substrate.

The third panel 400 may include a third substrate 410 which may be made of glass, plastic, or the like. The third substrate 410 may be rigid or flexible, and may be flat, or at least a part thereof may be curved.

A third electrode 490 may be positioned on the third substrate 410. The third electrode 490 may include a conductive material, and more particularly may include a transparent conductive material such as ITO and IZO, a metal, etc. The third electrode 490 may receive a voltage from the polarization driver 20. The third electrode 490 may also be formed on the third substrate 410 as a single plate, or may be patterned to have a plurality of separated portions.

The fourth panel 500 may include a fourth substrate 510 which may be made of glass, plastic, or the like. The fourth substrate 510 may be rigid or flexible, and may be flat, or at least a part thereof may be curved.

A fourth electrode 590 may be positioned on the fourth substrate 510. The fourth electrode 590 may include a conductive material, and may include a transparent conductive material such as ITO and IZO, a metal, etc. The fourth electrode 590 may receive a voltage from the polarization driver 20. The fourth electrode 590 may also be formed on the fourth substrate 510 as a single plate, or be patterned to have a plurality of separated portions.

The liquid crystal layer 6 includes a plurality of liquid crystal molecules 61. The liquid crystal molecules 61 are substantially perpendicularly aligned with respect to the fourth panel 500 and the third panel 400 when no electric field is generated in the liquid crystal layer 6, or may have pre-tilts in predetermined directions. The liquid crystal molecules 61 may be nematic liquid crystal molecules.

A third alignment director 41 is positioned on an inner surface of the third panel 400 over the third electrode 490, and a fourth alignment director 51 is positioned on an inner surface of the fourth panel 500 over the fourth electrode 590. The third alignment director 41 and the fourth alignment director 51 may be horizontal alignment layers, and may be provided with an alignment force by various methods such as a rubbing process or a photo-alignment process, to align liquid crystal molecules 61 that approach the third panel 400 and the fourth panel 500 in predetermined pre-tilt directions. When using a rubbing process, the horizontal alignment layer may be an organic horizontal alignment layer. When using a photo-alignment process, a photo-polymerization material may be formed by irradiating light, such as ultraviolet light, after coating an alignment material that includes a photosensitive polymer material on the inner surfaces of the third panel 400 and the fourth panel 500.

Alignment directions of two alignment directors 41 and 51 positioned on the inner surfaces of the third panel 400 and the fourth panel 500 are substantially parallel to each other. The third alignment directors 41 may be aligned in a direction parallel with the x axis, and the fourth alignment directors 51 may be aligned in a direction parallel with the y axis.

An operation of a 3D image display device according to the exemplary embodiment will now be described with reference to FIG. 6 and FIG. 7.

Referring to FIG. 6, the display panel DP may display an elemental image during 1 frame in the 3D mode. One frame may include a first sub-frame and a second sub-frame as two sub-frames.

During the first sub-frame, the 3D image display device may be driven so that the image provides parallax in the first direction to the user. For example, during the first sub-frame, the third electrode 490 and the fourth electrode 590 of the polarization switching panel SW may receive a first common voltage Vcom1.

At the first time t11 at which the first sub-frame starts, the second electrodes 191 of the liquid crystal lens panel LC may receive a second voltage V2, and the first electrodes 193 and the upper-panel electrode 290 may receive a second common voltage Vcom2. The voltages applied to the first electrodes 193, the second electrodes 191, and the upper-panel electrode 290 may be sustained until the second time t12 at which the first sub-frame ends.

During the first sub-frame, in the liquid crystal layer 6 of the polarization switching panel SW, the liquid crystal molecules 61 may be arranged in a form similar to the arrangement of liquid crystal molecules SL1 in the polarization switching panel SW as described in FIG. 3. Therefore, during the first sub-frame, the polarization switching panel SW may change the polarization direction of the incident light to the x-axis direction.

More specifically, during the first sub-frame, an electric field may be generated by a voltage difference between the second electrodes 191 and the upper-panel electrode 290. In the liquid crystal layer 3 of the liquid crystal lens panel LC, the liquid crystal molecules 31 may thus be arranged in a form similar to the arrangement of the liquid crystal molecules LC1 in the liquid crystal lens panel LC as described in FIG. 3. Therefore, during the first sub-frame, the liquid crystal lens panel LC may form a plurality of lenses of which refractive indices are changed along the x axis. The plurality of lenses may extend along the y-axis direction.

During the second sub-frame, the 3D image display device may be driven so that the image provides parallax in the second direction to the user. For example, at the second time t12 at which the second sub-frame starts, the third electrode 490 may receive a first voltage V1, and during the second sub-frame, the fourth electrode 590 may receive the first common voltage Vcom1. The voltage applied to the third electrode 490 and fourth electrodes 590 may be sustained until the second time t13 at which the second sub-frame ends.

At the second time t12, the first electrodes 193 of the liquid crystal lens panel LC may receive the second voltage V2, and the second electrodes 191 and the upper-panel electrode 290 may receive the second common voltage Vcom2. The voltage applied to the first electrodes 193, the second electrodes 191, and the upper-panel electrode 290 may be sustained until the third time t13 at which the second sub-frame ends.

Accordingly, during the second sub-frame, an electric field may be generated by a voltage difference between the third electrode 490 and the fourth electrode 590. In the liquid crystal layer 6 of the polarization switching panel SW, the liquid crystal molecules 61 may thus be arranged in a form similar to the arrangement of liquid crystal molecules SL2 in the polarization switching panel SW as described in FIG. 4.

Therefore, during the second sub-frame, the polarization switching panel SW may sustain the polarization direction of incident light in the y-axis direction.

Also during the second sub-frame, an electric field may be generated by a voltage difference between the first electrodes 193 and the upper-panel electrode 290. In the liquid crystal layer 3 of the liquid crystal lens panel LC, the liquid crystal molecules 31 may thus be arranged in a form similar to the arrangement of liquid crystal molecules LC2 in the liquid crystal lens panel LC as described in FIG. 4. Therefore, during the second sub-frame, the liquid crystal lens panel LC may form a plurality of lenses of which refractive indices are changed along the y axis. The plurality of lenses may be laid out along the x-axis direction.

The 3D image display device according to an exemplary embodiment may display images while providing the parallax in the first direction and the second direction to the user during the first sub-frame and the second sub-frame of one frame, respectively. Therefore, the user may perceive the parallax in the x-axis direction and the y-axis direction, so as to feel a more natural 3D effect.

Referring to FIG. 7, the display panel DP may instead display a 2D image during 1 entire frame in a 2D mode. During one frame, the 3D image display device may be driven so that a 2D image is displayed to the user. For example, during one frame, the third electrode 490 and the fourth electrode 590 of the polarization switching panel SW may receive the first common voltage Vcom1, and the second electrodes 191, the first electrodes 193, and the upper-panel electrode 290 of the liquid crystal lens panel LC may receive the second common voltage Vcom2.

Thus, light of a 2D image emitted from the display panel DP may be recognized by the user in a state that the polarization direction of light is changed. Therefore, the 3D image display device according to an exemplary embodiment may display a 2D image to the user.

Further, in the 3D image display device according to an exemplary embodiment, reflection of external light may be reduced, since the polarization switching panel SW may change the polarization direction of light.

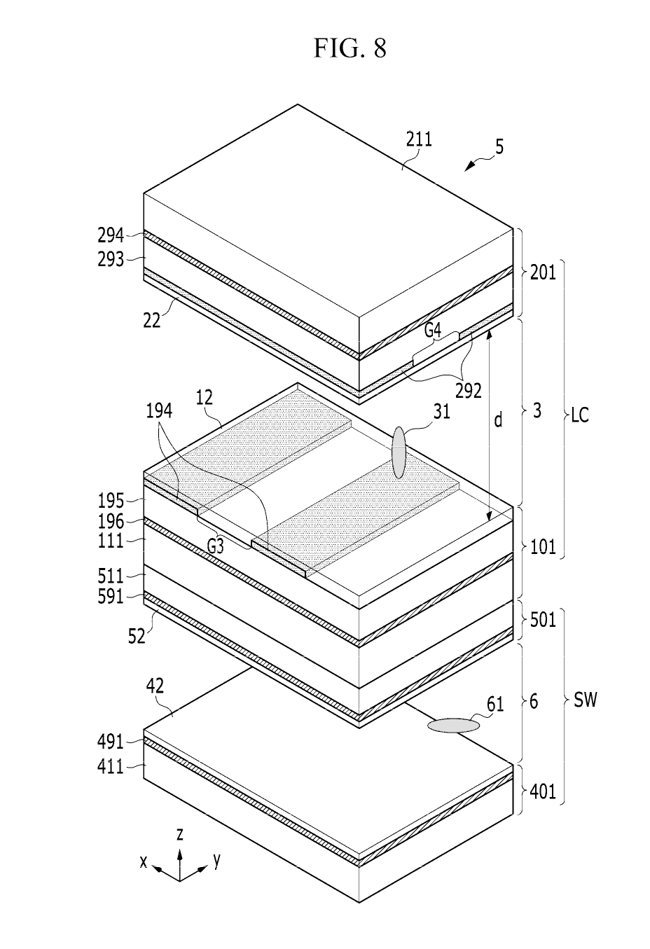

Referring to FIG. 8 to FIG. 10, the 3D image display device and associated driving method according to an exemplary embodiment will now be described.

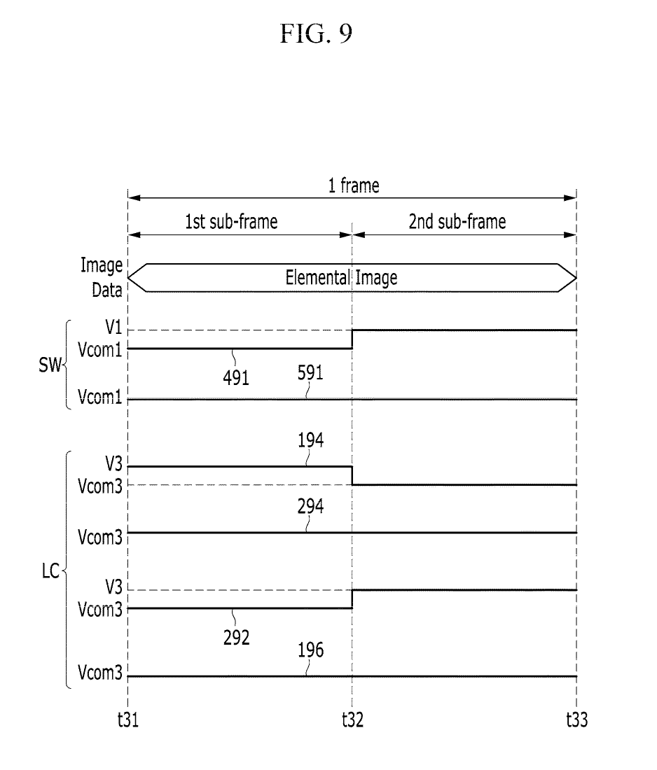

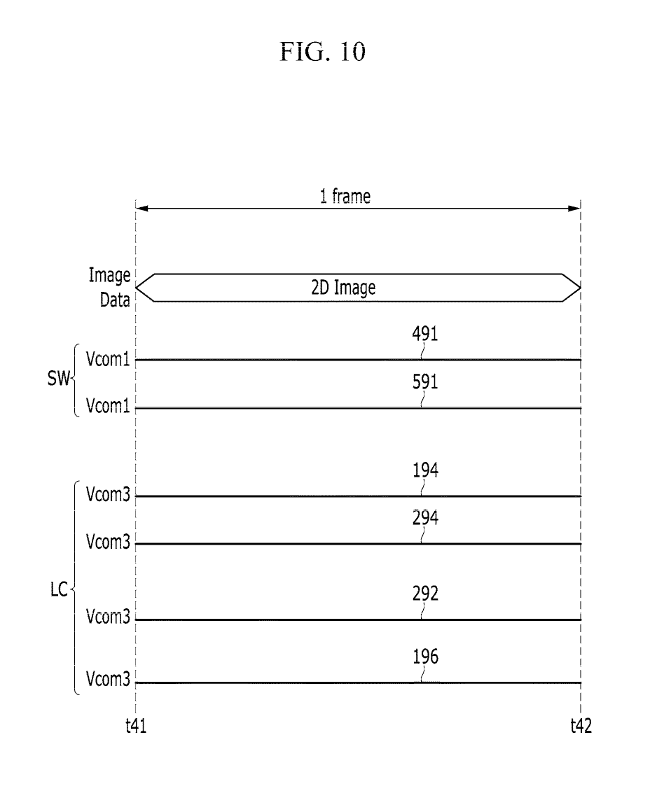

FIG. 8 is a perspective view illustrating a 3D image display device 5 according to an exemplary embodiment, and FIG. 9 and FIG. 10 are timing diagrams for a method of driving the 3D image display device according to an exemplary embodiment.

As shown in FIG. 8, the 3D image display device according to an exemplary embodiment may include a liquid crystal lens panel LC and a polarization switching panel SW.

The liquid crystal lens panel LC may include a first panel 101 and a second panel 201 facing each other, with a liquid crystal layer 3 positioned therebetween.

The first panel 101 may include a first substrate 111 which may be made of glass, plastic, or the like. The first substrate 111 may be rigid or flexible, and may be flat, or at least a part thereof may be curved.

A lower-panel electrode 196 may be positioned on the first substrate 111. The lower-panel electrode 196 may include a conductive material, and in particular may include a transparent conductive material such as ITO and IZO, a metal, etc. The lower-panel electrode 196 may receive a voltage from the liquid crystal lens driver 30. The lower-panel electrode 196 may also be formed on the first substrate 111 as a single plate, or be patterned to have a plurality of separated portions.

An insulation layer 195 may be positioned on the lower-panel electrode 196. The insulation layer 195 may be formed of at least one of an organic insulator and an inorganic insulator.

A plurality of second electrodes 194 may be positioned on the insulation layer 195. The second electrodes 194 may include a conductive material, and more specifically may include a transparent conductive material such as ITO and IZO, a metal, etc. The second electrode 194 may receive a voltage from the liquid crystal lens driver 30.

The plurality of second electrodes 194 may be successively arranged in a certain direction, for example, the x-axis direction, and each of the second electrodes 194 may extend in a direction perpendicular to the direction of arrangement, for example, the y-axis direction.

A width of a space G3 between adjacent second electrodes 194 may be adjusted as desired based on a design of the 3D image display device.

The second panel 201 may include a second substrate 211 which may be made of glass, plastic, or the like. The second substrate 211 may be rigid or flexible, and may be flat, or at least a part thereof may be curved.

An upper-panel electrode 294 is positioned on the second substrate 211. The upper-panel electrode 294 may include a conductive material, and in particular may include a transparent conductive material such as ITO and IZO, a metal, etc. The upper-panel electrode 294 may receive a voltage from the liquid crystal lens driver 30. The upper-panel electrode 294 may also be formed on the second substrate 211 as a single plate, or be patterned to have a plurality of separated portions.

An insulation layer 293 may be positioned on the upper-panel electrode 294. The insulation layer 293 may be formed of at least one of an organic insulator and an inorganic insulator.

A plurality of first electrodes 292 may be positioned on the insulation layer 293. The first electrodes 292 may include a conductive material, and in particular may include a transparent conductive material such as ITO and IZO, a metal, etc. The first electrodes 292 may receive a voltage from the liquid crystal lens driver 30.

The plurality of first electrodes 292 may be successively arranged along a certain direction, for example, the y-axis direction, and each of the first electrodes 292 may extend in a direction perpendicular to the direction of arrangement, for example, the x-axis direction.

A width of a space G4 between adjacent first electrodes 292 may be adjusted as desired, based on a design of the 3D image display device.

Since the previous description regarding the first panel 101, the second panel 201, and the liquid crystal layer 3 is substantially the same as the description regarding the first panel 100, the second panel 200, and the liquid crystal layer 3 of FIG. 5, redundant description thereof is omitted.

The polarization switching panel SW may include a third panel 401 and a fourth panel 501 facing each other, with a liquid crystal layer 6 positioned therebetween. The fourth panel 501 of the polarization switching panel SW may be bonded to the first panel 101 of the liquid crystal lens panel LC. Alternatively, the fourth panel 501 of the polarizing switching panel SW and the first panel 101 of the liquid crystal lens panel LC may be the same substrate.

The third panel 401 may include a third substrate 411 which may be made of glass, plastic, or the like.

A third electrode 491 may be positioned on the third substrate 411. The third electrode 491 may include a conductive material, and particularly may include a transparent conductive material such as ITO and IZO, a metal, etc. The third electrode 491 may receive a voltage from the polarization driver 20. The third electrode 491 may also be formed on the third substrate 411 as a single plate or patterned to have a plurality of separated portions.

The fourth panel 501 may include a fourth substrate 511 which may be made of glass, plastic, or the like. The fourth substrate 511 may be rigid or flexible, and may be flat, or at least a part thereof may be curved.

A fourth electrode 591 may be positioned on the fourth substrate 511. The fourth electrode 591 may include a conductive material, and as an example may include a transparent conductive material such as ITO and IZO, a metal, etc. The fourth electrode 591 may receive a voltage from the polarization driver 20. The fourth electrode 591 may also be formed on the fourth substrate 511 as a single plate or patterned to have a plurality of separated portions.

The liquid crystal layer 6 includes a plurality of liquid crystal molecules 61. The liquid crystal molecules 61 are substantially perpendicularly aligned with respect to the fourth panel 501 and the third panel 401 when no electric field is generated in the liquid crystal layer 6, or may have pre-tilts in predetermined directions. The liquid crystal molecules 61 may be nematic liquid crystal molecules.

Since the previous description regarding a first alignment director 12, a second alignment director 22, a third alignment director 42, and a fourth alignment director 52 is substantially the same as the description regarding the first alignment director 11, the second alignment director 21, the third alignment director 41, and the fourth alignment director 51 of FIG. 5, repeated description thereof is omitted.

An operation of a 3D image display device according to the exemplary embodiment will be described with reference to FIG. 9 and FIG. 10.

Referring to FIG. 9, the display panel DP may display an elemental image during 1 frame in the 3D mode. One frame may include a first sub-frame and a second sub-frame.

During the first sub-frame, the 3D image display device may be driven so that the image provides parallax in the first direction to the user. For example, during the first sub-frame, the third electrode 491 and the fourth electrode 591 of the polarization switching panel SW may receive a first common voltage Vcom1.

At the first time t31 at which the first sub-frame starts, the second electrodes 194 of the liquid crystal lens panel LC may receive a third voltage V3, and the first electrodes 292, the upper-panel electrode 294, and the lower-panel electrode 196 may receive a third common voltage Vcom3. The voltage applied to the first electrodes 292, the second electrodes 194, the upper-panel electrode 294, and the lower-panel electrode 196 may be sustained until the second time t32 at which the first sub-frame ends.

During the first sub-frame, in the liquid crystal layer 6 of the polarization switching panel SW, the liquid crystal molecules 61 may be arranged in a form similar to the arrangement of liquid crystal molecules SL1 in the polarization switching panel SW as described in FIG. 3. Therefore, during the first sub-frame, the polarization switching panel SW may change the polarization direction of the incident light to the x-axis direction.

During the first sub-frame, an electric field may be generated by a voltage difference between the second electrodes 194 and the upper-panel electrode 294.

In the liquid crystal layer 3 of the liquid crystal lens panel LC, the liquid crystal molecules 31 may be arranged in a form similar to the arrangement of liquid crystal molecules LC1 in the liquid crystal lens panel LC as described in FIG. 3. Therefore, during the first sub-frame, the liquid crystal lens panel LC may form a plurality of lenses of which refractive indices are changed along the x axis. The plurality of lenses may extend in the y-axis direction.

During the second sub-frame, the 3D image display device may be driven so that the image provides parallax in the second direction to the user. For example, at the second time t32 at which the second sub-frame starts, the third electrode 491 may receive a first voltage V1, and during the second sub-frame, the fourth electrode 591 may receive the first common voltage Vcom1. The voltage applied to the third electrode 491 and fourth electrodes 591 may be sustained until the second time t33 at which the second sub-frame ends.

At the second time t32, the first electrodes 292 of the liquid crystal lens panel LC may receive the third voltage V3, and the second electrodes 194, the upper-panel electrode 294, and the lower-panel electrode 196 may receive the third common voltage Vcom3. The voltage applied to the first electrodes 292, the second electrodes 194, the upper-panel electrode 294, and the lower-panel electrode 196 may be sustained until the third time t33 at which the second sub-frame ends.

During the second sub-frame, an electric field may be generated by a voltage difference between the third electrode 491 and the fourth electrode 591. In the liquid crystal layer 6 of the polarization switching panel SW, the liquid crystal molecules 61 may be arranged in a form similar to the arrangement of liquid crystal molecules SL2 in the polarization switching panel SW as described in FIG. 4. Therefore, during the second sub-frame, the polarization switching panel SW may sustain the polarization direction of incident light in the y-axis direction.

During the second sub-frame, an electric field may be generated by a voltage difference between the first electrodes 292 and the upper-panel electrode 294. In the liquid crystal layer 3 of the liquid crystal lens panel LC, the liquid crystal molecules 31 may be arranged in a form similar to the arrangement of liquid crystal molecules LC2 in the liquid crystal lens panel LC as described in FIG. 4. Therefore, during the second sub-frame, the liquid crystal lens panel LC may form a plurality of lenses of which refractive indices are changed along the y axis. The plurality of lenses may extend in the x-axis direction.

The 3D image display device according to an exemplary embodiment may display images by providing the parallax in the first direction and the second direction to the user during the first sub-frame and the second sub-frame of one frame, respectively. Therefore, the user may synthetically recognize the parallax in the x-axis direction and the y-axis direction, so that he or she may feel a more natural 3D effect.

Referring to FIG. 10, the display panel DP may display a 2D image during 1 entire frame in the 2D mode. During one frame, the 3D image display device may be driven so that a 2D image is displayed to the user. For example, during one frame, the third electrode 491 and the fourth electrode 591 of the polarization switching panel SW may receive the first common voltage Vcom1, and the second electrodes 194, the first electrodes 292, the upper-panel electrode 294, and the lower-panel electrode 196 of the liquid crystal lens panel LC may receive the second common voltage Vcom2.

Thus, light of a 2D image emitted from the display panel DP may be recognized by user in a state that the polarization direction of light is changed. Therefore, the 3D image display device according to an exemplary embodiment may display a 2D image to the user.

Further, the 3D image display device according to an exemplary embodiment may reduce reflection of external light, since the polarization switching panel SW may change the polarization direction of light.

While the inventive technology has been described in connection with what is presently considered to be practical exemplary embodiments, it is to be understood that the invention is not limited to the disclosed embodiments, but, on the contrary, is intended to cover various modifications and equivalent arrangements included within the scope of the appended claims. Various features of the above described and other embodiments can be mixed and matched in any manner, to produce further embodiments consistent with the invention.

What is claimed is:

1. A 3D image display device, comprising:
a display panel configured to display an image;
a liquid crystal lens panel configured to selectively form a plurality of first lenses each extending in a first direction and successively arranged along a second direction which crosses the first direction, and to selectively form a plurality of second lenses each extending in the second direction and successively arranged along the first direction; and
a polarization switching panel between the display panel and the liquid lens panel, the polarization switching panel configured to selectively alter an optical axis of light incident from the display panel.

2. The 3D image display device of claim 1, wherein the polarization switching panel includes:
a first panel including a lower panel electrode;
a second panel facing the first panel and including an upper panel electrode; and
a first liquid crystal layer between the first panel and the second panel and including a plurality of liquid crystal molecules.

3. The 3D image display device of claim 2, wherein
the first panel further includes a first aligner aligned in the first direction and the second panel further includes a second aligner aligned in the second direction.

4. The 3D image display device of claim 2, wherein
the polarization switching panel is configured to change the optical axis of light according to a difference between a voltage applied to the lower panel electrode and a voltage applied to the upper panel electrode.

5. The 3D image display device of claim 1, wherein
the liquid crystal lens panel is further configured to form the plurality of first lenses while the polarization switching panel alters the optical axis of light.

6. The 3D image display device of claim 1, wherein
the liquid crystal lens panel includes a plurality of first electrodes extended in the first direction and successively arranged along the second direction, as well as a plurality of second electrodes extended in the second direction and successively arranged along the first direction, and
wherein the first lenses are formed when a first voltage is applied to the plurality of first electrodes and a first common voltage different from the first voltage is applied to the plurality of second electrodes.

7. The 3D image display device of claim 6, wherein the liquid crystal lens panel includes:
a first panel including the plurality of first electrodes, an insulation layer on the plurality of first electrodes, and the plurality of second electrodes on the insulation layer;
a second panel facing the first panel and including an upper panel electrode; and
a second liquid crystal layer between the first panel and the second panel and including a plurality of liquid crystal molecules.

8. The 3D image display device of claim 6, wherein
the liquid crystal lens panel includes a first panel including a lower panel electrode and a first insulation layer on the lower panel electrode, the plurality of first electrodes being on the first insulation layer,
a second panel facing the first panel and including the plurality of second electrodes, and
a second liquid crystal layer between the first panel and the second panel and including a plurality of liquid crystal molecules.

9. A method of driving a 3D image display device which includes a display panel displaying an image, a liquid crystal lens panel, and a polarization switching panel between the display panel and the liquid lens panel, the method comprising:
during a first frame period and when the display panel is driven in a 3D mode for display of a 3D image, forming a plurality of first lenses each extending in a first direction and successively arranged along a second direction which crosses the first direction; and
during a second frame period subsequent to the first frame period, and while the display panel is driven in the 3D mode, forming a plurality of second lenses extended in the second direction arranged in the first direction during a second frame subsequent to the first frame.

10. The method of claim 9, wherein
the forming a plurality of first lenses includes driving the polarization switching panel to change an optical axis of light during the first frame period.

11. The method of claim 9, wherein
the forming a plurality of second lenses includes driving the polarization switching panel to sustain the optical axis of light during the second frame period.

12. The method of claim 11,
wherein the polarization switching panel includes a first panel including a lower panel electrode, a second panel facing the first panel and including an upper panel electrode, and a first liquid crystal layer formed between the first panel and the second panel and including a plurality of liquid crystal molecules; and
wherein the driving the polarization switching panel further includes applying different voltages to the lower panel electrode and the upper panel electrode.

13. The method of claim 9,
wherein the liquid crystal lens panel may include a plurality of first electrodes extended in the first direction and successively arranged along the second direction, and a plurality of second electrodes extended in the second direction and successively arranged along the first direction; and
wherein the forming a plurality of first lenses further includes applying a first voltage to the plurality of first electrodes and a second voltage to the plurality of second electrodes, the first voltage being different from the second voltage.

14. A 3D image display device, comprising:
a display panel configured to display an elemental image obtained from different viewpoints of a 3D object;
a polarization switching panel on the display panel and programmed to alternately change an optical axis of light of the elemental image during consecutive frames; and
a liquid crystal panel configured to form, during respective and consecutive image frame periods, a plurality of first lenses each extending in a first direction and successively arranged along a second direction which crosses the first direction, and a plurality of second lenses each extending in the second direction and successively arranged along the first direction.

15. A liquid crystal lens panel, comprising:
a first panel including a plurality of first electrodes extended in a first direction and arranged along a second direction different from the first direction, and a plurality of second electrodes extended in the second direction and arranged along the first direction;
a second panel facing the first panel and including an upper panel electrode; and
a liquid crystal layer between the first panel and the upper panel electrode and including a plurality of liquid crystal molecules.

16. The liquid crystal lens panel of claim 15, wherein the first panel further includes:
a first substrate on which the plurality of first electrodes is located; and
an insulation layer on the plurality of first electrodes,
wherein the plurality of second electrodes is positioned on the insulation layer.

17. The liquid crystal lens panel of claim 15, wherein
the second panel further includes a second substrate on which the upper panel electrode is located.

18. A liquid crystal lens panel, comprising:
a first panel including a plurality of first electrodes extended in a first direction and arranged along a second direction different from the first direction, and an lower panel electrode;
a second panel facing the first panel and including a plurality of second electrodes extended in the second direction and arranged along the first direction, and an upper panel electrode; and
a liquid crystal layer between the plurality of first electrodes and the plurality of second electrodes and including a plurality of liquid crystal molecules.

19. The liquid crystal lens panel of claim 18, wherein the first panel further includes:
a first substrate on which the lower panel electrode is located; and
a first insulation layer on the lower panel electrode,
wherein the plurality of first electrodes is positioned on the first insulation layer.

20. The liquid crystal lens panel of claim 18, wherein the second panel further includes:
a second substrate on which the upper panel electrode is located; and
a second insulation layer on the upper panel electrode,
wherein the plurality of second electrodes is positioned on the first insulation layer.
